(19) United States
(12) Patent Application Publication
(10) Pub. No.: US 2025/0017424 A1
(43) Pub. Date: Jan. 16, 2025

(54) FOOD CHOPPING MACHINE, IN PARTICULAR FOR MAKING PESTO

(71) Applicants: Anis HAFAIEDH, Genova (IT); Nicholas Luca DIDDI, Stella (IT)

(72) Inventors: Anis HAFAIEDH, Genova (IT); Nicholas Luca DIDDI, Stella (IT)

(21) Appl. No.: 18/713,377

(22) PCT Filed: Nov. 25, 2022
(86) PCT No.: PCT/IB2022/061428

§ 371 Date: May 24, 2024

(30) Foreign Application Priority Data
Nov. 26, 2021 (IT) 102021000029951

(51) Int. Cl. A47J 43/044; A47J 43/28

(52) U.S. Cl. CPC A47J 43/044; A47J 43/28

(57) ABSTRACT

Food chopping machine comprising at least one mortar (2) and at least one pestle (1), being present means for moving (3) said pestle (1) and/or said mortar (2), configured to displace the pestle (1) and/or the mortar (2) in such a way that the pestle (1) exerts a pressure on the mortar (2), so as to chop the food inserted inside the mortar (2).

A food distributing device (4) is present, which distributing device (4) comprises a plurality of food compartments (40, 41, 42, 43, 44, 45, 46), which compartments (40, 41, 42, 43, 44, 45, 46) comprise dispensing means configured to dispense the food inside the mortar (2) automatically.

The present invention relates to a food chopping machine comprising at least one mortar and at least one pestle.

The machine also comprises means for moving the pestle and/or the mortar, configured to displace the pestle and/or the mortar in such a way that the pestle exerts a pressure on the mortar, so as to chop the food inserted inside the mortar.

In particular, the invention refers to the preparation of pasta sauces or the like and preferably, but not exclusively, to the preparation of pesto.

Pesto is a foodstuff that can be produced both industrially and artisanally. In this latter case, the preparation can be entrusted to the manual skills of an operator and must be combined with the authenticity of the ingredients for the best results to be obtained, for example those described in the specification called “Genoese pesto” for obtaining the PDO name.

The artisanal preparation of the pesto also allows tasting this sauce in the best way, that is, within a limited time from the preparation.

It is therefore clear that the possibility of having an effective and timely preparation method is a key factor for the success of the preparation of pesto.

It is also evident how complex it is to be able to maintain the taste expectations of a pesto that complies with the specifications, but at an industrial level.

In fact, the quality of the ingredients is not enough, but the production methodology must also have the production characteristics at the artisanal level.

A possible solution relating to the automation of the movement of the pestle and of the mortar, in order to reproduce the manual skills of an operator is described in Italian patent 102010901832502, the content of which is to be considered an integral part of this patent application.

The device described within this patent, however, does not make it possible to obtain an industrial production of pesto that is fully automated and, at the same time, allows the quality of the pesto produced to be maintained at an artisanal level.

In fact, the aforementioned patent merely describes a possible implementation of the movement of pestle and mortar, but in any case requires the presence of an operator for adding the ingredients constituting the pesto.

The operator must be a specialized operator, that is, he must know the type and amount of the ingredients, as well as the time order according to which to add the ingredients.

There is therefore a need not satisfied by the systems known in the state of the art, to make a machine capable of making a sauce for pasta or the like, at an industrial level, but which presents the taste characteristics and quality of a sauce made at an artisanal level.

The present invention achieves the above purposes by making a machine as described above, in which a food distributing device is present, comprising a plurality of food compartments, comprising dispensing means configured to dispense food into the mortar automatically.

In accordance with this configuration, therefore, the machine subject-matter of this invention allows to automate not only the movement of the pestle and of the mortar and therefore the chopping of the food, but also the addition of the ingredients, in such a way that any operator, even a non-specialized one, by filling the compartments of the distributing device, can obtain a pesto of quality.

Starting from this generic configuration, it is possible to envisage expedients, which will be described later through the illustration of some embodiment examples, which improve the degree of automation of the production of pesto and that allow the best treatment and conservation of the ingredients used.

As will be evident from the illustration of some embodiment examples, the machine subject-matter of this invention allows to realize a system that allows to produce a pesto that is exportable and marketable in its highest qualitative form, but through an industrial type process.

An industrial production not only has the obvious advantage of reducing costs, but allows to obtain a “repeatable” pesto, that is, whose taste characteristics can be found in all the pesto packages that are produced by the machine subject-matter of this invention.

These and further objects of the present invention are achieved by a food chopping machine according to the appended independent claim and the sub claims.

Optional features of the machine of the invention are contained in the appended dependent claims, which form an integral part of the present disclosure.

These and other features and advantages of the present invention will become clearer from the following disclosure of some embodiment examples illustrated in the accompanying drawings in which:

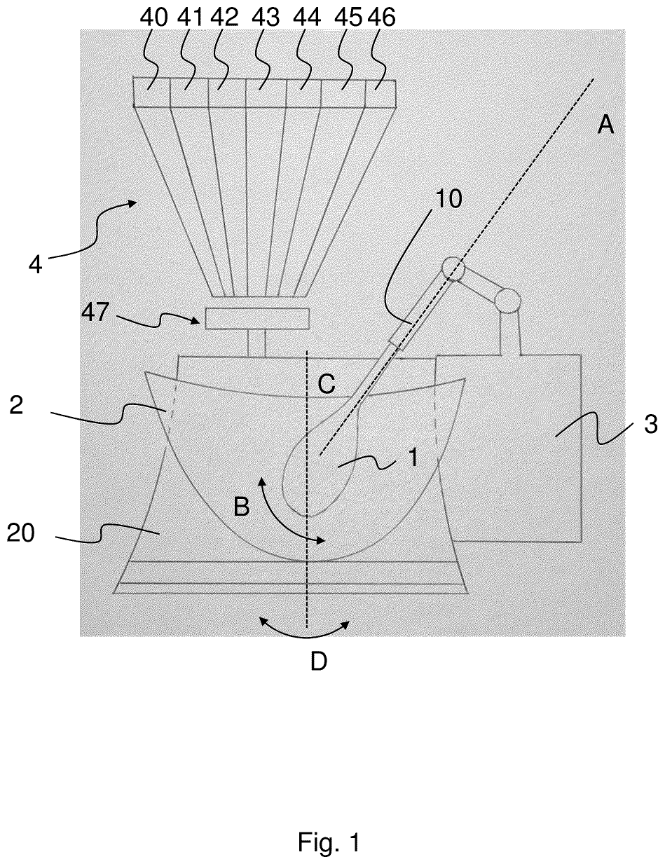

FIG. 1 illustrates an exemplary principle diagram of a possible embodiment of the machine subject-matter of this invention;

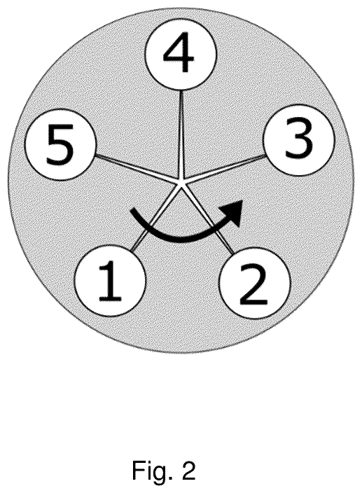

FIG. 2 illustrates a principle diagram of a detail of the machine subject-matter of this invention, according to a possible embodiment;

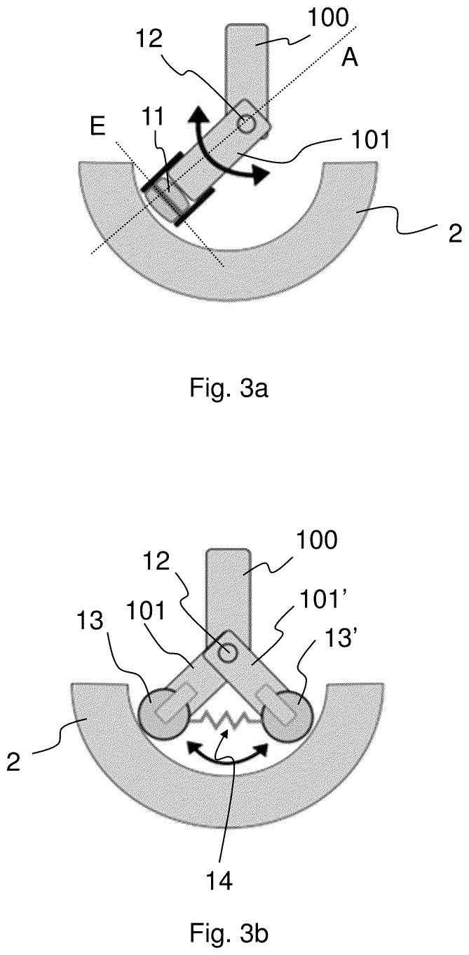

FIGS. 3a and 3b illustrate two possible embodiments of the pestle and of the mortar belonging to the machine subject-matter of this invention;

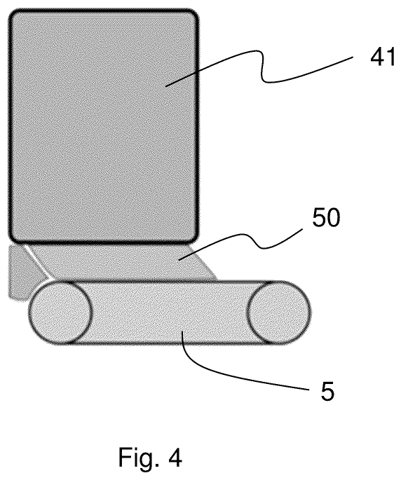

FIG. 4 illustrates a principle diagram of a detail belonging to the machine subject-matter of this invention.

It is specified that the Figures enclosed to this patent application illustrate only some possible embodiments of the chopping machine subject-matter of this invention, to better understand the advantages and characteristics described.

These embodiments are therefore to be understood as purely illustrative and not limiting the inventive concept of the present invention, namely that of providing a food chopping machine capable of making a pesto at an industrial level, which presents the gustatory characteristics of a pesto made at an artisanal level, through automation of the entire production procedure.

With particular reference to FIG. 1, the machine subject-matter of this invention comprises a pestle 1 and a mortar 2, which are moved by movement means.

The movement means can be constituted by actuators 3 and can be configured to move the pestle 1 and the mortar 2, alternately or simultaneously.

According to the illustrated embodiment variant, the pestle 1 is supported by a support arm 10 moved by the actuators 3, which can be configured to displace the pestle 1 towards the mortar 2, so that it exerts a pressure on the internal walls of the mortar 2 to chop the food inserted inside the mortar.

It follows that the pestle 1 can be moved with different degrees of freedom, it can move along a straight line, as well as along a plane or it can even run along the entire surface of the internal walls of the mortar 2, based on operational needs and based on the configuration of the actuators 3.

For example, the pestle 1 may translate along the axis A and/or rotate about the axis A and/or oscillate in the directions indicated by the arrow B.

For simplicity of construction, it is possible to limit the movements of the pestle 1, by combining the displacements of the pestle 1 with displacements of the mortar 2.

The mortar 2 is in fact supported by a support base 20 movable by the actuators 3.

The actuators 3 can rotate the mortar 2 about the axis C and/or translate it along the axis C and/or oscillate it in the directions indicated by the arrow D.

The food placed inside the mortar 2 is then chopped by the cooperation between the pestle 1 and the mortar 2, for example, in the case of pesto, it is possible to insert the appropriate ingredients to chop and mix them in such a way as to create a coarse mixture, which is typical of pesto made with mortar.

Therefore, the movement of the mortar 2 and of the pestle 1 causes the food inserted inside the mortar 2 to be chopped and can be both synchronous and independent.

Preferably, for simplicity of construction, making the two movements independent is preferred.

Movements that can be variously coupled are then listed below.

### Mortar 2 Movement:

Rotary along vertical axis C, continuous rotation or once the mortar is positioned in the station]
Oscillatory around a horizontal axis transverse to C
Rotary intermittently or in alternating directions

### Pestle 1 Movement:

Planetary type, with rotary movement of the pestle 1 around its axis A, according to a movement known as “Orbital gear mechanism”
Of the oscillatory type along a horizontal axis
Of the spring type: the pestle 1 axis is made with a flexible element, which with appropriate calculation of the forces guarantees constant pressure on the internal surface of the mortar 2.
Of the type with rotation generated by eccentric shaft and inclined pestle,
Actuated by an anthropomorphic arm, i.e. robots with 4 or more degrees of freedom that simulates the movement of the human arm,
Actuated by axes with XY coordinates on the horizontal plane,
Movement in the horizontal XY plane, of the Scara type with two rotary joints and pestle adjustable in height
Of the elliptical type with spring end stop to ensure contact on the mortar, but with mortar not synchronous with the pestle pounding.
Pestle 1 consisting of one or two wheels free to rotate thanks to the contact with the mortar 2, as illustrated in FIG. 3a. The wheel 11 is free to rotate around the E axis, the inclination of which is variable.

In fact, the pestle 1 consists of two arms 100 and 101, pivoted together at point 12, so that the arm 101 can oscillate with respect to the arm 100, in order to adjust its position.

Once the position of the arm 101 has been established with respect to the arm 100, it is fixed, so that the wheel 11 rotates thanks to the friction with the mortar 2, in motion, generating the crushing of the basil. A similar device can be imagined like the wheels of the millstones for olive oil, i.e. in general stone wheels that are free to rotate and which under their weight create the crushing/pounding operation.
System of two balls 13 and 13′ in contact with the mortar 2, free to rotate and approach the walls of the mortar 2 thanks to a spring mechanism 14, as illustrated in FIG. 3b. The mechanism settles on the curvature of the mortar 2 thanks to a spring 14 or flexible or elastic element, which allows the displacement of the balls 13 and 13′. The balls 13 and 13′ may be fixed or free to rotate.

In this case the pestle comprises three arms, 100, 101 and 101′, pivoted together at a point 12, in a manner similar to FIG. 3a. In this case, the pivot point 12 works synergistically with the spring 14, as it allows the reciprocal narrowing/distancing of the balls 13 and 13′ through the oscillation of the arms 101 and 101′.

The arms 101 and 101′ are thus free to oscillate around the pivot 12.

The activation of the movement of the pestle 1 and/or of the mortar 2 is preferably controlled by a control unit, not illustrated in the Figure, which generates command signals for the actuators 3, and/or for the mortar 2 and/or for the pestle 1, so as to operate the pestle 1 and/or the mortar until a homogeneous mixture is obtained, as will be described later.

FIG. 1 illustrates an embodiment of the machine subject-matter of this invention in which there are a single mortar 2 and a single station including dosing/weighing and emptying.

Alternatively, it is possible to provide a machine that has two processing stations, each provided with mortar 2.

With this in mind, i.e. a machine that includes more than one processing station, it is possible to provide that the distributing device 4 is envisaged positioned above one or more processing stations and that it can serve one or more processing stations.

It is also possible to provide more than one distributing device 4 at each processing station.

Each mortar 2 has weighing means, so that a mortar 2 is dedicated to the basil pounding operation and one dedicated to the dosing/weighing operations of the other ingredients and emptying.

Means for displacing the mortars 2 are also present, in such a way that the mortars 2 are reversed to allow the two processing stations to operate continuously.

Similarly, it is possible to envisage any number of processing stations.

In this case, the means for displacing the mortars 2 can be made up of turntable or carousel mechanisms, in which each station is assigned with different operations, with the aim of minimising machine downtime and maximising production, a specific configuration for an industrial type production.

A principle diagram of this configuration is illustrated in FIG. 2, in which there are five processing stations, in particular:
Station 1: insertion of garlic/pine nuts+basil+salt and pounding
Station 2: gradual insertion of basil and salt and pounding
Station 3: gradual insertion of basil and salt and oil, and pounding
Station 4: insertion of oil and cheese and mixing
Station 5: emptying and mechanical cleaning of the mortar 2.

This solution is oriented towards a semi-industrial machine that allows a continuous production of pesto. More generally, this architecture allows to speed up the process by dividing the slowest operation (pounding) according to the number of pestle processing stations. This solution also allows more versatility for the individual stations, which can be fitted with the necessary tools or dedicated to a specific single operation (for example, the possibility of inserting a cleaning station, which washes and dries the mortar after the emptying station).

The implementation of the functions present in the stations can be entrusted to a single motor with different kinematic chains or to different specialized motors for each function. The functions present in the stations can be independent, that is, operated at different time intervals and above all stopped in the event of completion of the work in the single station. The stations need not be arranged according to a symmetrical or polygonal geometry, but the arrangement may vary according to the overall size of the stations.

A further variant provides that the stations are completely independent of each other (i.e. not moved by a rigid turntable or carousel mechanism), in order to optimise the working times of each individual station and the geometry itself of the machine.

Advantageously, the machine subject-matter of this invention provides for an automatic distribution also of the ingredients to be inserted inside the mortar 2.

For this reason, a distributing device 4 is present, which has a plurality of compartments 40-46 adapted to house the food to be ground in the mortar, separately.

In the particular case of pesto being made, the distributing device 4 has seven different compartments 40-46, containing basil, Parmesan cheese, Sardinian pecorino cheese, oil, pine nuts, garlic, coarse salt.

Advantageously, the compartments 40-46 have different sizes, based on the overall sizes of the individual ingredients and the amount necessary to produce pesto.

For example, the basil compartment will be larger than the compartment in which the pine nuts or oil are to be inserted.

Furthermore, according to a preferred embodiment, the compartments 40-46 are made of transparent material.

The distributing device 4 has means for dispensing the ingredients contained within the compartments 40-46 so as to empty the ingredients inside the mortar 2.

According to the embodiment variant illustrated in FIG. 1, the distributing device 4 is positioned above the mortar 2, so as to exploit the force of gravity to facilitate the dispensing of food from the distributing device 4 to the mortar 2.

For example, the dispensing means may comprise doors that open/close to ensure the passage of food.

The opening/closing, together with the opening/closing timings, will be commanded by the command unit which will provide specific algorithms containing instructions for the execution of the pesto production process.

From the generic configuration described above, it is evident how it is possible to make pesto with a few simple steps.

For example, the ingredients can be inserted in the appropriate compartments 40-46 with predetermined amounts and the process can be started so that the control unit allows dispensing the ingredients within the scheduled times.

The movement of the pestle 1 and/or of the mortar 2, will allow chopping and mixing the ingredients, so as to create the pesto.

Therefore, from a home/artisanal perspective, no further components are required, as the ingredients are already inserted in the compartments 40-46 in a predetermined amount, based on the amount of pesto to be produced.

According to a preferred embodiment, however, dosing means are present, aimed at controlling the amount of a particular type of ingredient that is dispensed.

Such dosing means are schematically shown in FIG. 1 with the number 47 and may for example comprise sensors aimed at detecting the amount of the dispensed ingredient, such as for example scales or computer vision means, or the like.

In the case of olive oil special sensors/scales may not be needed. It being a liquid, it could be calculated mathematically how much is the oil discharge, based on the force of gravity, and taking into account the dimensional parameters of the dispensing nozzle, as well as the dispensing times.

It follows that the dosing means 47 can be integrated into each compartment 40-46 and be different according to the type of ingredient to be measured.

The dosing of a liquid ingredient, such as oil, can be carried out according to different components, in particular:
Litre counter sensor, i.e. measuring the flow rate exiting the compartment,
Plunger dosing device with chamber adjustment,
Dosing by weight difference and discharge by free drop
lobe pump
small flow peristatic pump,

The dosing of powdered ingredients or solid ingredients that are previously ground, either inside the compartment or prior to insertion into the compartment, such as garlic/pine nuts, salt and cheeses, can be carried out according to different components, in particular:
stellar valve, i.e. rotary valve with compartments,
screw, of the constant or variable pitch spiral type,
dose measurement by weight difference in the ingredient compartment
measurement of the dose in a dedicated compartment for ingredient pre-insertion.

Basil leaves, on the other hand, can be dosed:
By means of a star valve, i.e. rotary valve with compartments,
By means of a screw, of the constant or variable pitch spiral type,
By means of variable speed belt positioned under the basil compartment 41, as illustrated in FIG. 4. The belt 5 with rough surface slides under the compartment 41, containing basil. The leaves are directed by a rubbery surface 50 that prevents the leaves from being discharged to the sides. The entire system can be provided with a load cell for weighing or working on a separate weighing station.
Dose measurement by weight difference in the ingredient compartment
Measurement of the dose in a dedicated tank for ingredient pre-insertion inside the relevant compartment.

Alternatively or in combination with the dosing means described above, it is possible to provide for a dosing by weight of the mortar 2.

Both in the case of use of single mortar 2, and in the single processing station, it is possible to envisage using a weighing system that comprises the mortar 2 itself. In order not to stress the load cell, it is necessary to perform the pounding by disconnecting the operation from weighing; therefore, two positions are provided for the mortar: weighing position or working position. The weighing position could be realized, for example, by lifting the mortar on a special platform provided with a load cell; for the pounding operation the platform is lowered and the mortar is again rigidly constrained ready for pounding.

Advantageously, the dosing means allow to obtain a dosage of the ingredients in real time.

In particular, basil leaves to be ground in the mortar during the pounding operation can be provided, so as to allow a pounding of quality.

Regardless of the embodiment, the dosing means 47 communicate with the control unit, which comprises a microprocessor adapted to execute algorithms that, by reading the sensor data and by commanding the actuators 3, will allow to control the amounts of product and the production process, as well as the dispensing timings.

The control unit may comprise a user interface, made in the manner known to the state of the art, such as a display or a remote control.

The user interface allows to warn operators about the conditions of the machine, used amount of ingredients, amount of pesto produced, etc.

Consequently, an operator inserts each ingredient into a special compartment 40-46, starts the pesto production program and the control unit controls the various components described, adjusting the movement of the pestle 1 and/or of the mortar 2, timings and dispensing amount for the ingredients by the distributing device 4.

The dropping speed of each ingredient being known, it may also be sufficient controlling the dispensing timings, as the control unit may allow the dispensing of a certain ingredient for a certain timing so as to guarantee, i.e. “drop”, a certain amount of the specific ingredient.

The control of the dispensing timings is not exclusively related to the opening/closing of the compartment door to dispense the ingredient, but can also be related to the time order in which the ingredients are inserted into the mortar 2, i.e. giving priority to the ingredients that must be ground first.

According to one embodiment, it is possible that one or more compartments have means for grinding the ingredient inserted within the compartment itself.

For example, the compartments in which the cheeses are to be inserted may have such grinding means.

Alternatively, it is possible to envisage inserting the cheeses already in grated form.

According to a preferred embodiment, in addition to timings and amounts, it is possible to control the temperature.

In particular, some compartments, such as the compartment in which the basil is inserted and the cheese compartments, can be refrigerated (about 4° C.), to keep the state and freshness of the ingredients intact.

Therefore, in order to keep all the products fresh and not overheat the machine subject-matter of this invention, a temperature control apparatus will be provided.

Cooling will be carried out through a common compressor, but for reduced versions of the machine it will be possible to take into account using Peltier cells.

According to a possible embodiment, it is possible to provide for a mixing chamber at the exit from the compartments, which may or not be integrated within the dosing means 47.

This mixing chamber allows mixing two or more ingredients, before these ingredients are chopped in the mortar 2.

For example, if the recipe envisaged steps intermediate to grinding, such as mixing garlic and pine nuts, before they are inserted separately into the mortar, the mixing chamber would allow the execution of this step.

Based on what has been described, it is clear that the use of different processing stations or in any case the intermittent use of the pestle requires a coarse cleaning operation to remove the semi-finished product stuck to the pestle.

For this reason, according to a possible embodiment, it is possible to provide a cleaning system, which must come into operation when the change of station takes place, i.e. when the pestle 1 is lifted from the mortar 2.

The cleaning system may be realised according to different embodiments, such as:
rubbery element in contact with the pestle that forces the material to drop during lifting of the pestle
variation of the rotation speed of the pestle on its axis, i.e. rapid acceleration of the rotation speed to perform a detachment by centrifugal force.
jet of compressed air around the pestle or in areas where residues tend to accumulate.

In addition to the pestle cleaning system, especially in the case of ‘semi-industrial’ application, it could be useful to provide for an automated washing of the mortar or accessories.

In the case of a machine with single mortar, the washing should be carried out by a series of properly oriented air/water jets.

In the case of a machine with stations, the mortar could be washed in a dedicated station. This station should be provided with water/pressurised air jets or mechanical brushes, and a chamber to delimit the volume thereof, i.e. to prevent the discharge of the jets and collect the waste water from the washing.

Washing could also be carried out in the station dedicated to emptying. That is, in succession to emptying, for example by replacing the container dedicated to the collection of ready-made pesto with a platform with pressurised nozzles for washing.

The washing operation also requires subsequent drying, to prevent the subsequent production of pesto from being contaminated by the washing water. The drying operation can take place by blowing air.

From the characteristics just described, it is evident how the machine subject-matter of this invention allows to make the pesto by controlling specific dosages of the ingredients, with predetermined timings and with a temperature control.

The control unit obviously supervises the operation of the machine, not only by generating command signals for activating the dispensing means and the movement means for pestle 1 and/or mortar 2, but also by checking that the correct amounts are used and blocking the production process once all the ingredients have been inserted and ground in the mortar 2 and with the correct amounts.

Once the pesto has been made, it is possible to envisage a procedure for emptying the mortar 2, in order to collect the produced pesto.

It is therefore possible to envisage specific emptying means according to needs and development technology.

For example, the mortar 2 could be emptied through special pieces of the machine that are extractable and replaceable: for example, the bottom of the mortar, where pesto is created, could be extracted directly.

Alternatively or in combination, a valve and an emptying system and possible application of mechanical or pneumatic overpressure could be provided.

In this case, the pesto will pass into a container, possibly refrigerated, connected to a tap/funnel from which the pesto will be discharged to fill one or more jars.

Alternatively or in combination, it is possible to provide an automated spatula, used to group the pesto and discharge it, transporting it, outside the mortar 2.

The spatula can be moved by an anthropomorphic robotic arm.

In addition to the described variants, it is possible to provide other embodiments of the system for emptying the mortar 2.

Simply this emptying system can be achieved by moving the mortar, that is momentary displacement from the station and overturning (or tilting) thereof.

According to the variant illustrated in the Figure, the distributing device 4 consists of a funnel element, inside which the various ingredients that “drop” inside the mortar 2 naturally and by gravity are inserted: each compartment 40-46 has the outlet directed towards the opening of the mortar 2, so there is no need to displace the distributing device 4.

However, it is possible to provide a different shape of the distributing device, such as a plurality of compartments aligned with each other and which slide on guides and rails so as to position the compartment that must dispense the ingredient, above the mortar.

Similarly, it is possible to provide a turntable of compartments, which rotate and position themselves above the mortar 2, based on the ingredient to be dispensed.

Finally, it is specified that, based on operational needs, i.e. home/industrial use, it is possible to vary the dimensions of the machine subject-matter of this invention, as well as to provide, also based on the dimensions, one or more pestles 1 that work simultaneously inside the same mortar 2.

According to a possible embodiment, it is possible to provide means for adjusting the atmosphere surrounding the processing zone.

These means may provide for the application of vacuum in the area dedicated to processing or in the pounding area only.

Alternatively or in combination, cooling of the processing area and of the processing tools is provided.

Alternatively or in combination it is possible to provide dispensing means for the application of inert gas (such as nitrogen) in the processing area, in an adequate percentage to decrease the oxidation conditions.

Finally, it is specified that it is possible to integrate the machine subject-matter of this invention with a packaging system downstream of the emptying station. The system should allow the automatic filling of jars through a dedicated line, with continuous flow of pesto exiting from the machine. The system should provide for the dosage of the amount of pesto and the insertion of a small dose of oil for the preservation of pesto in the jar.

While the invention is subject to various modifications and alternative constructions, some preferred embodiments have been shown in the drawings and described in detail.

It should be understood, however, that there is no intention to limit the invention to the specific illustrated embodiment but, on the contrary, the aim is to cover all the modifications, alternative constructions and equivalents falling within the scope of the invention as defined in the claims.

The use of “for example”, “etc.” or “or” refers to non-exclusive non-limiting alternatives, unless otherwise stated.

The use of “includes” means “includes but is not limited to”, unless otherwise stated.

1. Food chopping machine comprising at least one mortar and at least one pestle,
being present means for moving said pestle and/or said mortar, configured to displace the pestle and/or the mortar in such a way that the pestle exerts a pressure on the mortar, so as to chop the food inserted inside the mortar,
characterized in that
a food distributing device is present, which distributing device comprises a plurality of food compartments, which compartments comprise dispensing means configured to dispense the food inside the mortar automatically.

2. Machine according to claim 1, wherein said dispensing device is positioned above said mortar.

3. Machine according to claim 1, wherein means for setting the dispensing time are present.

4. Machine according to claim 1, wherein means for setting the amount of food dispensed are present.

5. Machine according to claim 1, wherein one or more compartments comprise food cooling means.

6. Machine according to claim 1, wherein one or more compartments comprise food grinding means.

7. Machine according to claim 1, wherein means for weighing the food present inside the mortar are present.

8. Machine according to claim 1, wherein a mixing chamber is provided between the distributing device and the mortar, which mixing chamber communicates with two or more compartments.

9. Machine according to claim 1, wherein means for emptying said mortar are provided.

10. Machine according to claim 1, wherein a control unit is present aimed at managing the operation of the displacement means and/or the dispensing means and/or the dispensing time setting means and/or the dispensing amount setting means and/or the grinding means and/or the cooling means.
